(19) United States
(12) Patent Application Publication
(10) Pub. No.: US 2021/0145025 A1
(43) Pub. Date: May 20, 2021

(54) Mycotoxin-Adsorbent Compound and Use Thereof

(71) Applicant: Tolsa, S.A., Madrid (ES)

(72) Inventors: Sara Martin Rodado, Madrid (ES); Francisco De Juan Garcia, Madrid (ES); Diego Martinez Del Olmo, Madrid (ES)

(21) Appl. No.: 16/632,456

(22) PCT Filed: Jul. 3, 2018
(86) PCT No.: PCT/EP2018/067904

§ 371 Date: Jan. 20, 2020

(30) Foreign Application Priority Data
Jul. 20, 2017 (EP) 17382479.8

(51) Int. Cl. A23K 20/28; A23K 10/37

(52) U.S. Cl. CPC A23K 20/28; A23K 10/37

(57) ABSTRACT

The present disclosure relates to a compound with mycotoxin-adsorbent properties. The compound includes at least one magnesium phyllosilicate in a percentage between 25% and 75% by weight of the total mixture, at least one aluminium phyllosilicate in a percentage between 25% and 85% by weight of the total mixture, and activated vegetable charcoal in a percentage between 1% and 10% by weight of the total mixture. Another object of the disclosure is the obtainment method and use of the compound as a raw material in the formulation of compound feed, as an additive in finished mixtures intended for direct consumption by the animal, or as an ingredient in the formulation of complex mycotoxin-adsorbent additives.

### TECHNICAL FIELD OF THE INVENTION

The object of the present invention falls under the agri-food sector. More particularly, it relates to a new compound with mycotoxin-adsorbent properties. Another object of the invention is the use of said compound as a raw material in the formulation of compound feed, as an additive in finished mixtures intended for direct consumption by the animal or as an ingredient in the formulation of complex mycotoxin-adsorbent additives.

### BACKGROUND OF THE INVENTION

Mycotoxins are toxic secondary metabolites produced by organisms of the Fungi Kingdom by means of metabolic processes.

Currently, more than 400 mycotoxins are known, which are differentiated by their chemical and biological structure and by their toxicological properties. Most of them are highly dangerous and can cause diseases called mycotoxicosis, affecting animals' health even in very low concentrations (Kabak, B., et al., 2006, Critical Reviews in Food Science and Nutrition 46(8), 593-619). The most relevant are aflatoxins, fumonisins, zearalenone, trichothecenes, ochratoxins and ergot alkaloids.

From among all the existing mycotoxins, one of the most toxic is deoxynivalenol (DON) or vomitoxin, belonging to the trichothecene family. These toxins are produced by fungi of the genus Fusarium (F. graminearum and F. sporotrichoides). The high contamination of raw materials and feed by DON is one of the main problems that affect animal production worldwide. The dangerousness of this mycotoxin lies in the difficulty of sequestering it and the strong impact it has on the affected animal. In general, DON causes vomiting, diarrhoea, irritation, haemorrhaging and necrosis in the digestive tract, in addition to causing refusal of feed. DON affects all animal species, particularly pig and cattle, causing adverse effects on the target organ (liver) and small intestine. In ruminants, miscarriages, vomiting and diarrhoea, loss of appetite and low milk production is observed, in addition to reproductive and immunosuppressive problems. In meat-producing ruminants, decreased growth and lower weight of the animals is observed. Pigs are the most sensitive to DON. Decreased growth and productivity, a lower conception rate, a lower number of live-born piglets and a smaller volume and concentration of sperm has been observed. Additionally, it causes vomiting in the pigs, diarrhoea and gastroenteritis and immunosuppressive problems. In poultry farming, it reduces the growth and production and quality of the eggs and causes intestinal and liver lesions.

Contamination by mycotoxins is therefore a major problem in the agri-food industry. In addition to the production and reproductive losses of the affected animals, it entails substantial economic losses in agricultural and livestock farms. One of the main drawbacks associated with mycotoxins is the difficulty in detecting the effects associated with their presence. The main symptoms depend on the concentration of mycotoxin, the animal's species, sex, age, exposure time, environment, nutrition or state of health. In general, certain symptoms caused by small concentrations of mycotoxins can be observed, such as weight loss, decreased food intake, nonspecific diarrhoea, metabolic fat and protein problems, decreased immunology, increased number of infectious diseases or reproductive problems and miscarriages. In some cases, mycotoxins can be toxic, teratogenic, mutagenic and carcinogenic. When the concentration of mycotoxins is high, they can even cause the death of the animal. It is therefore a very serious problem in the industry, which makes it necessary to find solutions that will make it possible to reduce contamination by mycotoxins with the object of improving animal health, yield and productivity.

In general, the different alternatives that exist in the state of the art to solve the problem of mycotoxins can be classified, according to their mode of operation, into:
(a) adsorbents: This technique consists of the use of substances which act as mycotoxin anchors, preventing them from being adsorbed by the animal (Gimeno, A., Martins, M. L., 2011, “Mycotoxins and mycotoxicosis in animals and humans.” SPECIAL NUTRIENTS, INC.). Boudergue, C. et al. have also described the use of an effective sequestrant which acts throughout the animal's digestive system (Boudergue, C. et al., 2009, “Review of mycotoxin-detoxifying agents used as feed additives: mode of action, efficacy and feed/food safety.” Scientific report issued to the EFSA, 192 p);
(b) modifiers of the mycotoxin structure: This technique is based on the use of substances that alter the structure of the mycotoxins to reduce their toxicity. Various inventions based on said technique have been disclosed in the state of the art. Thus, for example, patent application US2011/0189755 discloses substances capable of modifying the gene expression of mycotoxins by means of enzymatic degradations. In turn, patent U.S. Pat. No. 6,344,221 discloses an invention capable of deactivating ergot alkaloids through the use of a combination of a mineral clay and modified yeast cell wall extract;
(c) lastly, products capable of improving animal immunity have also been disclosed. Thus, for example, patent application US2003/0007982 discloses a method and composition capable of improving the animal's health through the use of a modified yeast cell wall extract. Likewise, international application WO2012/002871 discloses a composition for deactivating mycotoxins through the use of an immunostimulant, among other substances.

It has been demonstrated that bentonite-, attapulgite- and zeolite-type phyllosilicates, depending on the type, origin and purity, are materials commonly used as mycotoxin sequestrants and adsorbents. It has thus been disclosed in the publication of Ramos et al., 1996, Journal of Food Protection, 59(6) pp. 631-641, in U.S. Pat. No. 5,149,549 or in U.S. Pat. No. 5,165,946.

It has also been demonstrated that common mycotoxins, such as aflatoxins, fumonisins, zearalenone, trichothecenes or ergot alkaloids can be adsorbed with varying degrees of efficacy. It has thus been disclosed, for example, in patent IL99387.

Additionally, with the aim of sequestering a wide range of mycotoxins of varying polarities, the possibility of chemically modifying the phyllosilicates or preparing simple mixtures by adding other compounds has been disclosed (Lara et al., 1998, “Aluminosilicates and mycotoxin adsorption. Current issues facing the poultry industry,” 259-271. Midia Relaciones. Mexico D.F.). Among other examples, the use of quaternary ammonia salts (as in patent application MX2007008369), acids or acid compounds (US20160073662), calcined attapulgites (U.S. Pat. No. 5,935,623), hydrated sodium calcium aluminosilicates (HSCAS) (US2009/0117206), quaternary compounds (U.S. Pat. No. 6,827,959), organophyllosilicates (US20160339056), organic compounds (US2016/0287617), microspheres (US2011/0135796), humic acids (WO2011/146485), yeast walls (U.S. Pat. No. 6,045,834) and estevensites (US2008/0248155) has been proposed. However, none of these proposals describe the possibility of capturing deoxynivalenol (DON). In this regard, patents or patent applications have been found that disclose effective products against said mycotoxin (DON), generally through the addition of compounds that accompany phyllosilicates. Thus, for example, application US2010/0330235 discloses the addition of primary amines, application AU2012200952 discloses the addition of yeast enzymes, application US 2012/0027747 discloses the addition of resins or bacterial biomass, application US2015/0150285 discloses the addition of yeasts and international application WO2010/083336 discloses the addition of yeast walls.

All the foregoing applications disclose mixtures with compounds that claim to be deoxynivalenol structure modifiers. However, none of them disclose a change in the polarity of phyllosilicates for the purpose of adsorbing deoxynivalenol (DON). Therefore, none of them demonstrate that the compounds known in the state of the art are effective in themselves as adsorbents of said mycotoxin.

Alternatively, another option would be to use activated charcoal. Activated charcoal is an inorganic compound characterised mainly by having a very porous surface area (between 50 and 2,500 square metres per gram), enabling the adsorption of a large number of mycotoxins in the digestive tract of animals, including DON. However, it has the drawback that the doses at which it has proven its efficacy cause adsorption interferences with respect to other ingredients of the traditional formulation of animal feed, such as vitamins and minerals (Avantaggiato G. et al., 2004, Food and Chemical Toxicology, 42, 817-824). Previously, the inclusion of small doses of active (or activated) charcoal was studied in intimate mixtures of different phyllosilicates (US2012/0219683), but no study has been found that demonstrates its efficacy against vomitoxin.

Therefore, due to the sequestration of compounds such as vitamins and minerals (Na, K, Ca, P, Mg, Fe, Zn and Mn) by the activated charcoal at the therapeutic doses described to date, its use as a mycotoxin adsorbent is not recommended. Furthermore, as described previously, it has not been proven that it would be an effective product against DON at the doses at which the activated charcoal would not be toxic.

Therefore, an object of the present invention is to develop a new mycotoxin adsorbent that is particularly effective against DON at doses that are non-toxic to animals. The object is to present a solution that, in addition to being a mycotoxin adsorbent with broad-spectrum efficacy, would be a cheaper technical solution than those corresponding to the current products or additives of the state of the art.

### GENERAL DESCRIPTION OF THE INVENTION

Therefore, a first object of the invention is a new compound with mycotoxin-adsorbent properties, characterised in that it comprises a mixture of:
(a) at least one magnesium phyllosilicate in a percentage comprised between 25% and 75% by weight and more preferably between 20% and 50% by weight of the total mixture. Preferably, said magnesium phyllosilicate may consist of sepiolite;
(b) at least one aluminium phyllosilicate in a percentage comprised between 25% and 85% by weight and more preferably between 50% and 80% by weight of the total mixture. Preferably, said aluminium phyllosilicate may consist of a smectite. More preferably, said smectite may be natural sodium dioctahedral smectite; and
(c) activated vegetable charcoal in a percentage comprised between 1 and 10% by weight and more preferably between 1% and 3% by weight of the total mixture.

It has been demonstrated that the mixture of the foregoing ingredients in the described proportions has a special synergy, resulting in a surprising and unexpected effect with regard to the adsorption of mycotoxins and, particularly, vomitoxin.

Another object of the invention is the method for obtaining said compound, characterised in that it comprises intimately mixing all the components of the composition for the time required to achieve a homogeneous mixture thereof. In particular embodiments of the invention, mixing time may vary between 15 and 30 minutes.

Preferably, the mixture obtained may be subjected to a milling process (preferably dry) until obtaining a medium-sized particle preferably smaller than 0.15 mm, determined in accordance with a granulometric distribution system based on dry sieving using normalised sieves pursuant to specification ASTM E11. In this method, the sieves are chosen in accordance with the particle size of the sample to be analysed, in this case a mesh width of 0.15 mm. The analysis is performed by weighing an amount of sample. The content retained in the 0.15 mm mesh is determined by aspiration and the final content is weighed. The resulting residue of this sieving must not be greater than 5%.

Lastly, another object of the invention is the use of the claimed compound as a raw material in the formulation of compound feed, as an additive in finished mixtures intended for direct consumption by the animal or as an ingredient in the formulation of complex mycotoxin-adsorbent additives.

In particular, the claimed compound is especially effective in the treatment of contamination by mycotoxins such as aflatoxin B1, fumonisin, zearalenone, toxin T2, ochratoxin or DON of food intended for feeding animals of different groups such as, for example, land livestock animals, pets or aquaculture species. The mode of operation is by means of mycotoxin adsorption or sequestration.

Lastly, an object of the invention is the use of the compound that is the object of the invention for treating and/or preventing poisoning caused by inhalation, direct contact or ingestion of food contaminated by mycotoxins, known as mycotoxicosis. In particular, it is particularly effective for treating and/or preventing mycotoxicosis caused by deoxynivalenol.

### DETAILED DESCRIPTION OF THE INVENTION

Although the essential components of the compound that is the object of the invention have been described in the preceding section, the mixture of which has proven to be highly effective for mycotoxin adsorption, in particular embodiments of the invention the compound that is the object of the invention may comprise other components such as, for example, additives that modify their structural properties. Among other examples, buffer compounds may be used. In particular, these components may consist preferably of magnesium oxide, sodium carbonate or sodium bicarbonate, in addition to combinations thereof. Preferably, the percentage by weight of these compounds in the compound that is the object of the invention shall not exceed 5% by weight with respect to the total.

It has been proven that a particularly preferred mixture of the invention may consist of an intimate mixture of 19% by weight of sepiolite, 79% by weight of natural sodium bentonite and 2% by weight of activated vegetable charcoal. Surprisingly, this particular combination of the components of the mixture has proven to be especially effective in mycotoxin adsorption, as demonstrated below by the examples that accompany this description.

With regard to the type of presentation of the claimed compound, it has been demonstrated that there is no type of limitation in this regard and can be used both dry and wet, in the form of powder, solid granules or compact pellets, etc.

As described previously, different assays have demonstrated the great efficacy of the claimed compound in the adsorption of mycotoxins such as those listed in the preceding section and, in particular, in the natural sequestration of DON, without harming the animal.

Likewise, in comparison to other sequestrants of the state of the art, the compound that is the object of the invention offers the advantage of enabling a specific bond between the additive and the mycotoxin, said bond being irreversible. This has made it possible to achieve a bond capable of remaining stable throughout the transit of the compound through the different sections of the animal's digestive system (and, therefore, different pH levels). All this, moreover, with the additional advantage of being a highly specific compound, which prevents other types of compounds, such as vitamins or minerals, necessary for the animal, from being sequestered.

The claimed compound may therefore be used both in preventive treatments and in treatments of the side effects associated with the presence of mycotoxins.

Preferably, in the event of being used to prevent mycotoxicosis, the dose of the compound in the feed may vary between 1 kg and 2 kg per tonne of feed (i.e. in a percentage comprised between 0.1% and 0.2% by weight of the feed). In other cases, in which the object is to treat severe cases of mycotoxicosis, the dose of the compound in the feed may vary preferably between 3 kg and 4 kg of compound per tonne of feed (i.e. in a percentage comprised between 0.3% and 0.4% by weight of the feed).

In this manner, in general, the claimed compound may be used as a raw material in the formulation of feed. Preferably, the percentage of compound in the feed may vary between 0.1 and 0.4% by weight of the total feed.

In other embodiments, the claimed compound may be used as an additive in finished mixtures intended for direct consumption by the animal, in which case it may be supplied in a ratio of at least 0.5% by weight with respect to the total feed consumed in one day, both in monogastric and ruminant animals.

Lastly, in alternative embodiments of the invention, the claimed compound may be used in the formulation of complex mycotoxin-adsorbent additives. In this case, the percentage of the compound in the final formulation of the additive shall preferably exceed 1% by weight and more preferably 20% to 65% by weight of the total additive.

### BRIEF DESCRIPTION OF THE FIGURES

FIG. 1 shows the efficacy data corresponding to the dose of 2 kg per tonne of example 1.

FIG. 2 shows the efficacy data corresponding to the dose of 2 kg per tonne of example 2.

FIG. 3 shows the efficacy data corresponding to the dose of 2 kg per tonne of example 3.

FIG. 4 shows the efficacy data corresponding to the dose of 2 kg per tonne of example 4.

FIG. 5 shows the efficacy data corresponding to the dose of 2 kg per tonne of example 5.

FIG. 6 shows the efficacy data corresponding to the dose of 4 kg per tonne of example 1.

FIG. 7 shows the efficacy data corresponding to the dose of 4 kg per tonne of example 2.

FIG. 8 shows the efficacy data corresponding to the dose of 4 kg per tonne of example 3.

FIG. 9 shows the efficacy data corresponding to the dose of 4 kg per tonne of example 4.

FIG. 10 shows the efficacy data corresponding to the dose of 4 kg per tonne of example 5.

FIG. 11 shows the efficacy data corresponding to example 6.

FIG. 12 shows the data relative to efficacy against fumonisin corresponding to the comparative data of the present object of the invention compared to a mixture of a commercial product formed by phyllosilicates and yeast walls.

FIG. 13 shows the data relative to efficacy against zearalenone corresponding to the comparative data of the present object of the invention compared to a mixture of a commercial product formed by phyllosilicates and yeast walls.

FIG. 14 shows vitamin B6 recovery data at pH 2.

FIG. 15 shows vitamin B6 recovery data at pH 7.

### EXAMPLES

With the object of proving the efficacy of the claimed compound, a series of adsorption assays of different low-polarity mycotoxins under in vitro conditions, simulating the digestive tract of an animal, were conducted. In this regard, due to the complexity of conducting assays with live animals and to the large number of variables that influence final performance and to the difficulty of evaluating efficacy, the general criterion is to test the efficacy of the products in vitro using one of the most accurate analytical techniques, high performance liquid chromatography (HPLC). This technique is performed by adding the sequestrant compound to be analysed to 10 ml of a buffer solution at pH 3 containing the mycotoxin concentration to be studied. Next, the solution is incubated at 37° C. for 3 hours under agitation and the resulting solution containing non-sequestered mycotoxin is analysed using HPLC, said value being that corresponding to Adsorption. Next, the previous solution is discarded and, since the sequestrant is decanted at the bottom of the test tube, 10 ml of a buffer tampon at pH 6.5 is added thereto for the purpose of simulating the intestinal conditions of the animals. The solution is incubated at 37° C. for 3 hours under agitation and is analysed again using HPLC in order to analyse the mycotoxin released by the sequestrant (corresponding to the Desorption value).

It is important that the bond between the sequestrant and mycotoxin is maintained throughout the animal's digestive system, such that the mycotoxin is anchored to an acid pH (Adsorption) and is capable of remaining physically bonded to the sequestrant when a basic pH is reached (Desorption). The difference between Adsorption and Desorption is called Efficacy.

### Example 1

In this first example, the efficacy of a sequestrant compound in accordance with the present invention was assayed. In particular, the composition of said compound was 19% sepiolite, 79% natural sodium smectite and 2% activated vegetable charcoal. All the percentages are percentages by weight with respect to the total mixture.

This compound was subjected to an in vitro study of fumonisin adsorption efficacy at a dose of 2 kg and 4 kg per tonne of sequestrant compound. The conditions of said study consisted of a concentration of 2 ppm of mycotoxin, an adsorption pH of 3 and a desorption pH of 6.5.

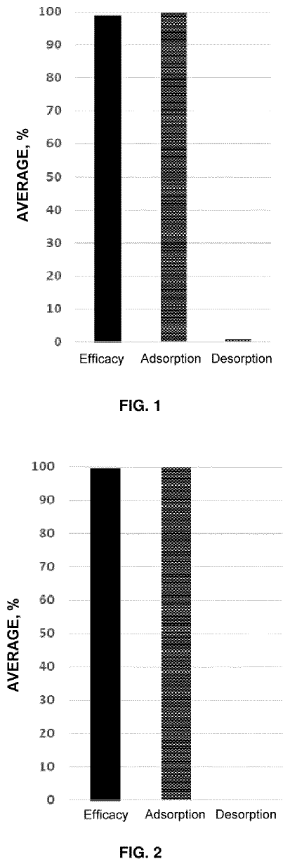

The efficacy data at a dose of sequestrant of 2 kg per tonne are represented in FIG. 1. As shown in said figure, an efficacy of 98.8% was achieved, with an adsorption of 99.5% and desorption of 0.7%.

The efficacy data at a dose of sequestrant of 4 kg per tonne are represented in FIG. 6. In this case, an efficacy of 99.9% was achieved, with an adsorption of 99% and desorption of 0.1%.

### Example 2

In this case, the efficacy of a compound with the same composition as that described in example 1 (consisting of 19% sepiolite, 79% natural sodium smectite and 2% activated vegetable charcoal) was assayed. This compound was subjected to an in vitro study of zearalenone adsorption efficacy at a dose of 2 kg and 4 kg per tonne of sequestrant compound. The conditions of said study were the same, consisting of 2 ppm of mycotoxin, an adsorption pH of 3 and a desorption pH of 6.5.

The efficacy data at a dose of sequestrant of 2 kg per tonne are represented in FIG. 2. As shown in said figure, an efficacy of 99.4% was achieved, with an adsorption of 99.7% and desorption of 0.3%.

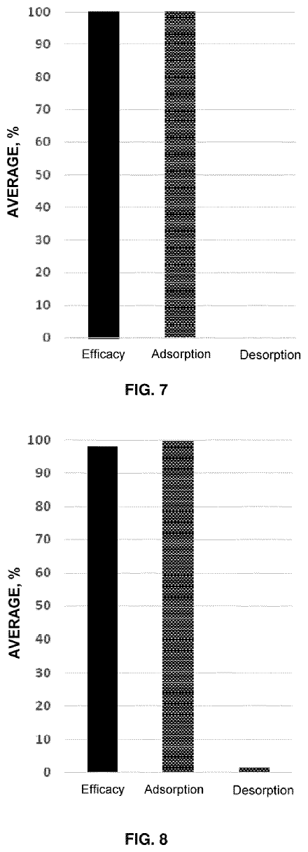

The efficacy data at a dose of sequestrant of 4 kg per tonne are represented in FIG. 7. In this case, an efficacy of 100% was achieved, with an adsorption of 100% and desorption of 0%.

### Example 3

In this case the efficacy of a compound with the same composition as that described in example 1 (consisting of 19% sepiolite, 79% natural sodium smectite and 2% activated vegetable charcoal) was assayed. This compound was subjected to an in vitro study of ochratoxin adsorption efficacy at a dose of 2 kg and 4 kg per tonne of sequestrant compound. The conditions of said study were the same, consisting of 2 ppm of mycotoxin, an adsorption pH of 3 and a desorption pH of 6.5.

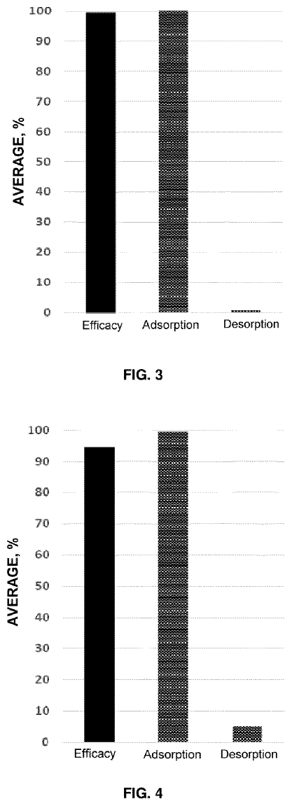

The efficacy data at a dose of sequestrant of 2 kg per tonne are represented in FIG. 3. As shown in said figure, an efficacy of 99.3% was achieved, with an adsorption of 100% and desorption of 0.7%.

The efficacy data at a dose of sequestrant of 4 kg per tonne are represented in FIG. 8. In this case, an efficacy of 98.1% was achieved, with an adsorption of 99.6% and desorption of 1.5%.

### Example 4

In this case, the efficacy of a compound with the same composition as that described in example 1 (consisting of 19% sepiolite, 79% natural sodium smectite and 2% activated vegetable charcoal) was assayed. This compound was subjected to an in vitro study of toxin T2 adsorption efficacy at a dose of 2 kg and 4 kg per tonne of sequestrant compound. The conditions of said study were the same, consisting of 2 ppm of mycotoxin, an adsorption pH of 3 and a desorption pH of 6.5.

The efficacy data at a dose of sequestrant of 2 kg per tonne are represented in FIG. 4. As shown in said figure, an efficacy of 94.4% was achieved, with an adsorption of 99.6% and desorption of 5.1%.

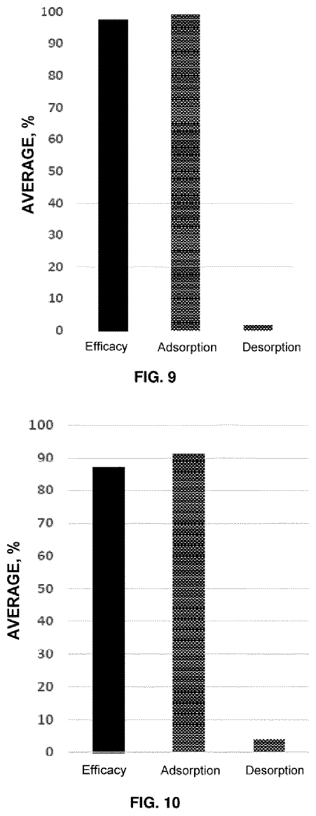

The efficacy data at a dose of sequestrant of 4 kg per tonne are represented in FIG. 9. In this case, an efficacy of 97.4% was achieved, with an adsorption of 99.1% and desorption of 1.7%.

### Example 5

In this case, the efficacy of a compound with the same composition as that described in example 1 (consisting of 19% sepiolite, 79% natural sodium smectite and 2% activated vegetable charcoal) was assayed. This compound was subjected to an in vitro study of deoxynivalenol adsorption efficacy at a dose of 2 kg and 4 kg per tonne of sequestrant compound. The conditions of said study were the same, consisting of 2 ppm of mycotoxin, an adsorption pH of 3 and a desorption pH of 6.5.

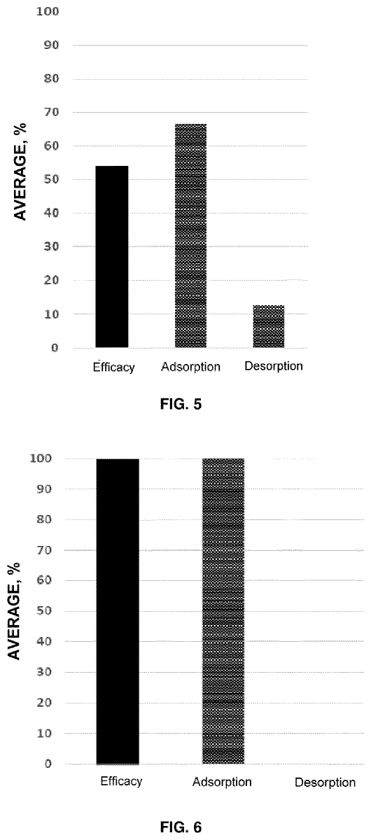

The efficacy data at a dose of sequestrant of 2 kg per tonne are represented in FIG. 5. As shown in said figure, an efficacy of 54% was achieved, with an adsorption of 66.5% and desorption of 12.5%.

The efficacy data at a dose of sequestrant of 4 kg per tonne are represented in FIG. 9. In this case, an efficacy of 87.2% was achieved, with an adsorption of 91% and desorption of 3.8%.

### Example 6

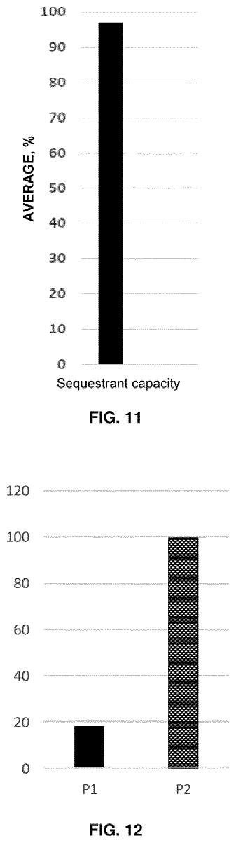

In this case, the efficacy of a compound with the same composition as that described in example 1 (consisting of 19% sepiolite, 79% natural sodium smectite and 2% activated vegetable charcoal) was assayed. This compound was subjected to an in vitro study of aflatoxin B1 adsorption efficacy at a dose of 0.2 kg per tonne of sequestrant compound. The conditions of said study were the same, consisting of 4 ppm of mycotoxin and an adsorption pH of 5. The efficacy data at the dose of sequestrant represented in FIG. 11 were 96.8%.

The foregoing examples therefore make it possible to demonstrate the great efficacy of the claimed compound in the sequestration of all types of mycotoxins, which proves its utility in the prevention and/or treatment of intoxications caused by these types of compounds.

### Example 7

In this case, the efficacy of a compound with the same composition as that described in example 1 (consisting of 19% sepiolite, 79% natural sodium smectite and 2% activated vegetable charcoal), represented in FIG. 12 as P2, was assayed. This compound was subjected to an in vitro study of fumonisin adsorption efficacy at a dose of 4 kg per tonne of sequestrant compound.

Next, a comparative study was conducted on a commercially available mycotoxin sequestrant compound composed of phyllosilicates and yeast walls, represented in FIG. 12 as P1. The conditions of said study were the same, consisting of 2 ppm of mycotoxin, an adsorption pH of 3 and a desorption pH of 6.5.

The assay made it possible to demonstrate the great efficacy of the compound that is the object of the invention compared to a commercially available sequestrant. In particular, as shown in FIG. 12, the efficacy achieved with the compound that is the object of the invention was 99.9%, compared to 17.8% obtained with the commercially available sequestrant.

### Example 8

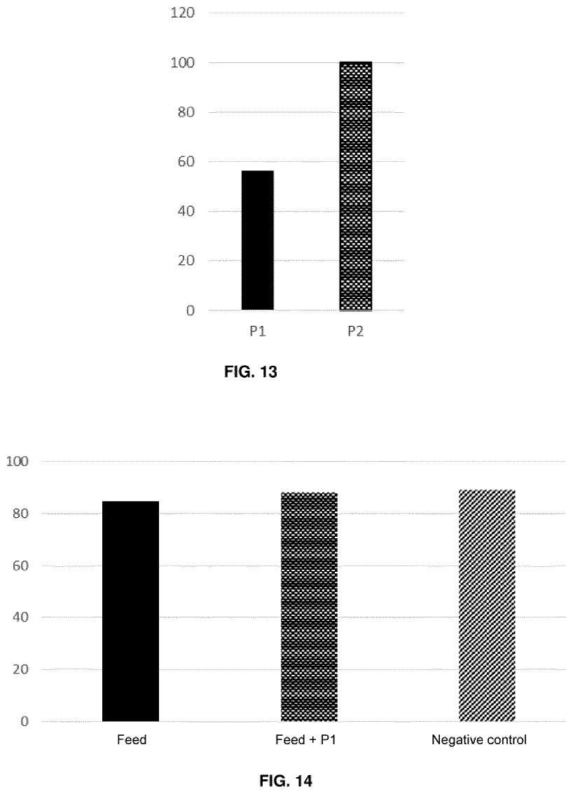

In this case, the efficacy of a compound with the same composition as that described in example 1 (consisting of 19% sepiolite, 79% natural sodium smectite and 2% activated vegetable charcoal), represented in FIG. 13 as P2, was assayed. This compound was subjected to an in vitro study of zearalenone adsorption efficacy at a dose of 4 kg per tonne of sequestrant compound.

Next, a comparative study was conducted on a commercially available mycotoxin sequestrant compound composed of phyllosilicates and yeasts, represented in FIG. 13 as P1. The conditions of said study were 2 ppm of mycotoxin, an adsorption pH of 3 and a desorption pH of 6.5.

Once again, the assay made it possible to demonstrate the great efficacy of the compound that is the object of the invention compared to a commercially available sequestrant. In particular, as shown in FIG. 13, the efficacy achieved with the compound that is the object of the invention was 100%, compared to 56.3% obtained with the commercially available sequestrant.

### Example 9

In this case, the sequestration security of vitamin B6 of a compound with the same composition as that described in example 1 (consisting of 19% sepiolite, 79% natural sodium smectite and 2% activated vegetable charcoal), was assayed.

This compound was subjected to an in vitro study of vitamin B6 sequestration security. In particular, three assays were conducted, the first using feed not including the compound that is the object of the invention, the second using feed including said compound and the third as a negative control, using only vitamin B6. The conditions of the three assays were identical, conducted at pH 2.

As can be observed in FIG. 14, the vitamin B6 recovery data were 84.5%, 88% and 89%, respectively. Therefore, this shows the high specificity of the compound that is the object of the invention, which is highly advantageous when used as an additive or component of the feed intended for animal nutrition.

### Example 10

In this case, the sequestration security of vitamin B6 of a compound with the same composition as that described in example 1 (consisting of 19% sepiolite, 79% natural sodium smectite and 2% activated vegetable charcoal), was assayed.

This compound was subjected to an in vitro study of vitamin B6 sequestration security. In particular, three assays were conducted, the first using feed not including the compound that is the object of the invention, the second using feed including said compound and the third as a negative control, using only vitamin B6. The conditions of the three assays were identical, conducted at pH 7.

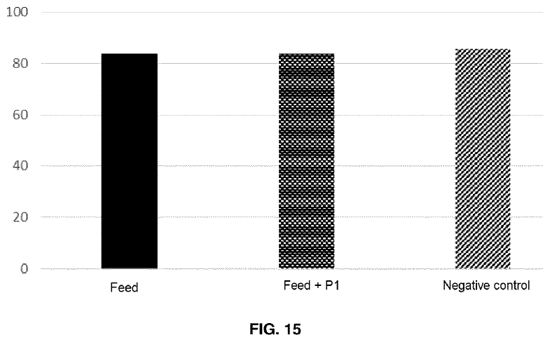

As can be observed in FIG. 15, the vitamin B6 recovery data were 83.7%, 83.6% and 85.7%, respectively. Therefore, this demonstrates the high specificity of the compound that is the object of the invention, which is highly advantageous when used as an additive or component of the feed intended for animal nutrition.

1. A compound with mycotoxin-adsorbent properties, comprising:
(a) at least one magnesium phyllosilicate in a percentage between 25% and 75% by weight of the total mixture;
(b) at least one aluminium phyllosilicate in a percentage between 25% and 85% by weight of the total mixture; and
(c) activated vegetable charcoal in a percentage between 1% and 10% by weight of the total mixture.

2. The compound according to claim 1, wherein the magnesium phyllosilicate comprises between 20% and 50% by weight of the total mixture.

3. The compound according to claim 1, wherein the aluminium phyllosilicate comprises between 50% and 80% by weight of the total mixture.

4. The compound according to claim 1, wherein the magnesium phyllosilicate is sepiolite.

5. The compound according to claim 1, wherein the aluminium phyllosilicate is selected from the group of smectites.

6. The compound according to claim 5, wherein the smectite is natural sodium dioctahedral smectite.

7. The compound according to claim 1, comprising a mixture of 19% by weight of sepiolite, 79% by weight of natural sodium bentonite, and 2% by weight of activated vegetable charcoal.

8. A method for obtaining the compound of claim 1, comprising:
(a) mixing at least one magnesium phyllosilicate in a percentage between 25% and 75% by weight of the total mixture;
(b) mixing at least one aluminium phyllosilicate in a percentage between 25% and 85% by weight of the total mixture; and
(c) mixing activated vegetable charcoal in a percentage between 1% and 10% by weight of the total mixture.

9. The method according to claim 8, further comprising: milling the compound until obtaining an average particle size smaller than 0.15 mm.

10. A method of preparing a compound feed, comprising: using the compound of claim 1 as a raw material.

11. The method according to claim 10, wherein the percentage of the compound in the feed comprises between 0.1% and 0.4% by weight of the total feed.

12. The compound according to claim 1, wherein the compound is an additive in mixtures for animal nutrition.

13. The compound according to claim 1, wherein the compound is an ingredient in the formulation of complex mycotoxin-adsorbent additives.

14. The compound according to claim 1, wherein the compound is an adsorbent of at least one mycotoxin aflatoxin B1, fumonisin, zearalenone, toxin T2, ochratoxin, or deoxynivalenol.

15. The compound according to claim 1, wherein compound is used for the treatment and/or prevention of mycotoxicosis.
